(19) United States
(12) Patent Application Publication
(10) Pub. No.: US 2022/0038433 A1
(43) Pub. Date: Feb. 3, 2022

(54) METHOD AND APPARATUS FOR SECURE MESSAGING BETWEEN NETWORK FUNCTIONS

(71) Applicant: Nokia Technologies Oy, Espoo (FI)

(72) Inventors: Nagendra S BYKAMPADI, Bangalore (IN); Uwe RAUSCHENBACH, Munich (DE)

(21) Appl. No.: 17/277,210

(22) PCT Filed: Sep. 10, 2019
(86) PCT No.: PCT/EP2019/074112

§ 371 Date: Mar. 17, 2021

(30) Foreign Application Priority Data
Sep. 21, 2018 (IN) 201841035682

(51) Int. Cl. H04L 29/06; H04W 12/03; H04L 29/08; H04W 12/106

(52) U.S. Cl. CPC H04L 63/0281; H04W 12/03; H04L 67/2819; H04L 63/168; H04L 63/0471; H04W 12/106; H04L 69/22

(57) ABSTRACT

In accordance with an example aspect, there is provided an apparatus, the apparatus being a security edge proxy configured to implement application layer security for data exchanged between two core networks, the apparatus being configured at least to: process a protocol message received in the apparatus to generate an inter-network message based on the received protocol message, the inter-network message comprising a first part and a second part, transmit the inter-network message toward a second security edge proxy, wherein the first part is integrity protected but not encrypted and comprises first content elements of the received protocol message, wherein the second part is integrity protected and encrypted and comprises second content elements of the received protocol message as well as corresponding path elements indicating locations in the protocol message where the second content elements are located within the protocol message.

### TECHNICAL FIELD

Various example embodiments relate to network function messaging.

### BACKGROUND

This section illustrates useful background information without admission of any technique described herein representative of the state of the art.

In 5G, a service-based architecture is introduced to model services as network functions (NFs) that communicate with each other using RESTful APIs. In the scenario where the two communicating NFs are in two different PLMNs, communication happens over a roaming interface between the two participating PLMNs.

To protect NF specific content in the messages that are sent over the roaming interface, each 5G PLMN has a Security Edge Proxy (SEPP) as the entity sitting at the perimeter of the PLMN network and acting as a gateway that protects all the traffic going out of the network. The SEPP implements application layer security for data exchanged between two inter-network NFs at the service layer.

Application layer security involves protecting information sent in various parts of the HTTP message, including HTTP Request/Response Line, HTTP header and HTTP Payload. However, some parts of this message may need to be modified by the intermediaries (IPX providers) between the two SEPPs.

### SUMMARY

Various aspects of examples of are set out in the claims.

In accordance with a first aspect of the present disclosure, there is provided an apparatus, the apparatus being a security edge proxy configured to implement application layer security for data exchanged between two core networks, the apparatus comprising at least one processing core, at least one memory including computer program code, the at least one memory and the computer program code being configured to, with the at least one processing core, cause the apparatus at least to process a protocol message received in the apparatus to generate an inter-network message based on the received protocol message, the inter-network message comprising a first part and a second part, transmit the inter-network message toward a second security edge proxy, wherein the first part is integrity protected but not encrypted and comprises first content elements of the received protocol message, wherein the second part is integrity protected and encrypted and comprises second content elements of the received protocol message as well as corresponding path elements indicating locations in the protocol message where the second content elements are located within the protocol message.

Various embodiments of the first aspect may comprise at least one feature from the following bulleted list:
the protocol is hypertext transfer protocol.
the two core networks are cellular communication network core networks.
the first part does not comprise indications of locations of the second content elements in the second part
the first part comprises indications of the second content elements wherein values of the second content elements are represented by replacement values or empty strings
the apparatus is configured to randomly generate the replacement values.

In accordance with a second aspect of the present disclosure, there is provided an apparatus, the apparatus being a security edge proxy configured to implement application layer security for data exchanged between two core networks, the apparatus comprising at least one processing core, at least one memory including computer program code, the at least one memory and the computer program code being configured to, with the at least one processing core, cause the apparatus at least to process an inter-network message received in the apparatus to generate a protocol message based on the received inter-network message, the inter-network message comprising a first part and a second part, and transmit the protocol message toward a network function, wherein the first part is integrity protected but not encrypted and comprises first content elements of the protocol message, wherein the second part is integrity protected and encrypted and comprises second content elements of the protocol message as well as corresponding path elements indicating locations in the protocol message where the second content elements are located within the protocol message.

In accordance with a third aspect of the present disclosure, there is provided a method, comprising processing a protocol message received in the apparatus to generate an inter-network message based on the received protocol message, the inter-network message comprising a first part and a second part, and transmitting the inter-network message toward a second security edge proxy, wherein the first part is integrity protected but not encrypted and comprises first content elements of the received protocol message, wherein the second part is integrity protected and encrypted and comprises second content elements of the received protocol message as well as corresponding path elements indicating locations in the protocol message where the second content elements are located within the protocol message.

Various embodiments of the third aspect may comprise at least one feature from the following bulleted list:
the protocol is hypertext transfer protocol.
the first part does not comprise indications of locations of the second content elements in the second part
the method is performed in a first security edge proxy configured to implement application layer security for data exchanged between two core networks, and the two core networks are cellular communication network core networks
the first part comprises indications of the second content elements wherein values of the second content elements are represented by replacement values or empty strings
the method comprises randomly generating the replacement values

In accordance with a fourth aspect of the present disclosure, there is provided a method, comprising processing an inter-network message received in the apparatus to generate a protocol message based on the received inter-network message, the inter-network message comprising a first part and a second part, and transmitting the protocol message toward a network function, wherein the first part is integrity protected but not encrypted and comprises first content elements of the protocol message, wherein the second part is integrity protected and encrypted and comprises second content elements of the protocol message as well as corresponding path elements indicating locations in the protocol message where the second content elements are located within the protocol message.

In accordance with a fifth aspect of the present disclosure, there is provided a non-transitory computer readable medium having stored thereon a set of computer readable instructions that, when executed by at least one processor of a security edge proxy, cause the security edge proxy to at least process a protocol message received in the security edge proxy to generate an inter-network message based on the received protocol message, the inter-network message comprising a first part and a second part, and transmit the inter-network message toward a second security edge proxy, wherein the first part is integrity protected but not encrypted and comprises first content elements of the received protocol message, wherein the second part is integrity protected and encrypted and comprises second content elements of the received protocol message as well as corresponding path elements indicating locations in the protocol message where the second content elements are located within the protocol message.

In accordance with a sixth aspect of the present disclosure, there is provided a non-transitory computer readable medium having stored thereon a set of computer readable instructions that, when executed by at least one processor of a security edge proxy, cause the security edge proxy to at least process an inter-network message received in the security edge proxy to generate a protocol message based on the received inter-network message, the inter-network message comprising a first part and a second part, transmit the protocol message toward a network function, wherein the first part is integrity protected but not encrypted and comprises first content elements of the protocol message, wherein the second part is integrity protected and encrypted and comprises second content elements of the protocol message as well as corresponding path elements indicating locations in the protocol message where the second content elements are located within the protocol message.

In accordance with a seventh aspect of the present disclosure, there is provided a computer program configured to cause at least the following, when run on a processor of a security edge proxy: processing a protocol message received in the security edge proxy to generate an inter-network message based on the received protocol message, the inter-network message comprising a first part and a second part, and transmitting the inter-network message toward a second security edge proxy, wherein the first part is integrity protected but not encrypted and comprises first content elements of the received protocol message, wherein the second part is integrity protected and encrypted and comprises second content elements of the received protocol message as well as corresponding path elements indicating locations in the protocol message where the second content elements are located within the protocol message.

In accordance with an eighth aspect of the present disclosure, there is provided a computer program configured to cause at least the following, when run on a processor of a security edge proxy: processing an inter-network message received in the security edge proxy to generate a protocol message based on the received inter-network message, the inter-network message comprising a first part and a second part, and transmitting the protocol message toward a network function, wherein the first part is integrity protected but not encrypted and comprises first content elements of the protocol message, wherein the second part is integrity protected and encrypted and comprises second content elements of the protocol message as well as corresponding path elements indicating locations in the protocol message where the second content elements are located within the protocol message.

### BRIEF DESCRIPTION OF THE DRAWINGS

For a more complete understanding of example embodiments, reference is now made to the following descriptions taken in connection with the accompanying drawings in which:

FIG. 1 shows an architectural drawing of a system of an example embodiment;

FIG. 2 shows a flow chart of a process of an example embodiment in a sending Security Edge Proxy;

FIG. 3 shows a flow chart of a process of an example embodiment in a receiving Security Edge Proxy;

FIG. 4 shows an example of a request message travel; and

FIG. 5 shows a block diagram of an apparatus according to an embodiment.

### DETAILED DESCRIPTION OF THE DRAWINGS

An example embodiment and its potential advantages are understood by referring to FIGS. 1 through 5 of the drawings. In this document, like reference signs denote like parts or steps.

FIG. 1 shows an architectural drawing of a system 100 of an example embodiment. FIG. 1 shows two public land mobile networks, PLMNs, 110 equipped with a first Network Function 120 that in a sending case is, for example, an Access and Mobility Function (AMF). The PLMNs each further comprise a security edge proxy (SEPP) 130. The SEPPs may be comprised in a core network of a cellular communications network, for example, such as a long term evolution, LTE, or fifth generation, 5G, core network. The SEPP of one PLMN acts as a sending SEPP 130 or sSEPP, and another one as a receiving SEPP 130 or rSEPP for one message. The SEPP 130 is a network node at the boundary of an operator's network that receives a protocol message, such as a hypertext transfer protocol, HTTP, message such as an HTTP request or HTTP response, from the network function AMF 120, applies protection for sending, and forwards the reformatted message through a chain of intermediate nodes such as IP eXchanges (IPX) 140 towards the rSEPP 130. Alternatively to a HTTP message, a real-time transport protocol, RTP, message, might be employed, for example. The SEPPs may exchange such inter-network messages with each other, which may be based on protocol messages traversing the respective core networks of the SEPPs. The inter-network messages may be seen as reformatted protocol messages of the core networks.

The rSEPP 130 is configured to receive an inter-network message from an intermediate node 130, re-assembles the message (e.g. HTTP request or response), and forward the re-assembled protocol message towards a second network function within its operator's network, e.g. an Authentication Server Function (AUSF) 150. The inter-network message may have been modified along the way, as is described herein. The re-assembled protocol message can alternatively be sent towards any other network function of the second network.

The intermediate node 140 or intermediary in short is, for example, a network node outside the operator's network that receives (directly or indirectly via other intermediaries) an inter-network message from the sSEPP 130, that may selectively modify the inter-network message according to a method for integrity protection with modification tracking, and forwards the message towards another intermediary 140 or to the rSEPP 130.

rSEPP 130 and sSEPP 130 may simultaneously act in both roles and their structure may be similar or identical, so both are denoted by same reference sign 130 while their role in delivery of a particular message is identified by use of the prefix “s” or “r” indicating whether they send or receive.

Data re-arrangement, known also as reformatting, according to some embodiments is next described. Assuming a protocol message is an HTTP message that complies to HTTP protocol, the message includes three protocol elements:

A) a request line or a response line. The request line consists, for example, of 1) an HTTP method, 2) a request URI that may contain an authority (host and port), a hierarchical part, a query and a fragment part, and 3) a protocol identifier. The response line consists, for example, of a protocol identifier, a status code and a status text.

B) A set of HTTP headers

C) An optional payload body, for instance formatted as JSON or XML

All three parts may contain parameters of a higher-layer protocol that is carried over HTTP, which may be of interest to the intermediaries for reading and/or modifying them.

For each part, the data are re-arranged (for instance by defining a suitable intermediate JSON structure or JSON structures) such that one of two protection methods may be applied to them: 1) integrity protection and 2) integrity protection combined with encryption.

Methods of protection of different parts can be freely chosen, while following standardized methods are disclosed for example:
a. Integrity Protection: The element(s) of the intermediate data structure that require(s) end to end, e2e, protection from modification by the intermediaries is/are signed, e.g. using JSON Web Signature (JWS) of RFC 7520, or, in general, a suitable public-key cryptosystem.
b. Integrity Protection with encryption: The element(s) requiring both integrity protection and encryption may be both signed, as in a), and ciphered using a suitable encryption algorithm. Examples of suitable algorithms include public-key crypto systems and symmetric ciphers. The signing may precede or follow the encrypting.

The integrity protection, optionally also with modification tracking, may be configured to store in a modification structure one or more modifications together with a signature of a respective entity such as the sSEPP 130 or an intermediate node 140 (e.g., for all modifications in common or separately for each modification). The modification structure comprises a modification chain which in an embodiment has one entry per intermediary. In an example embodiment, each modification chain entry is integrity protected with the signature of the intermediary that has performed the modification. This way, the rSEPP 130 can subsequently determine separately for each modification, whether it was performed by an authorized intermediary 140 and whether it complies with a modification policy for that intermediary.

In an embodiment, the original modification structure is dynamic such that each intermediate node 140 may add a new field to a modified item so forming a growing array.

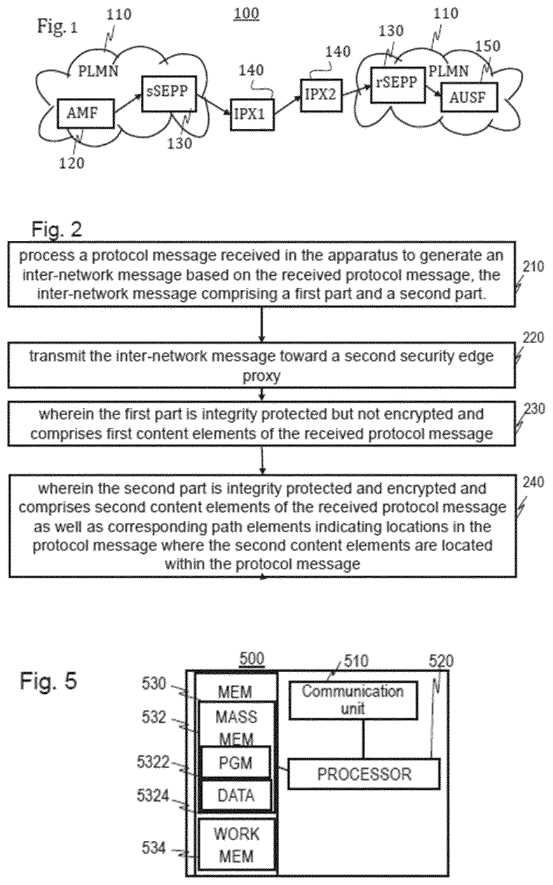

FIG. 2 shows a flow chart of a process of an example embodiment. The process may be run in an apparatus such as a sSEPP, or in a control device configured to control the functioning of a sSEPP.

Phase 210 comprises processing a protocol message received in the apparatus to generate an inter-network message based on the received protocol message, the inter-network message comprising a first part and a second part.

Phase 220 comprises transmitting the inter-network message toward a second security edge proxy. The first part is integrity protected but not encrypted and comprises first content elements of the received protocol message (230), and the second part is integrity protected and encrypted and comprises second content elements of the received protocol message as well as corresponding path elements indicating locations in the protocol message where the second content elements are located within the protocol message (240).

In an example embodiment, a modification structure is added to the inter-network message by some other node, such as a first intermediate node that forwards the inter-network message.

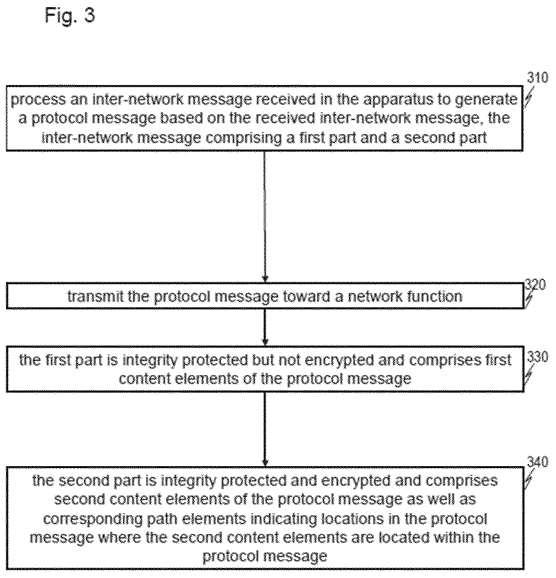

FIG. 3 shows a flow chart of a process of an example embodiment. The process may be run in an apparatus such as a rSEPP, or in a control device configured to control the functioning of a rSEPP. The rSEPP 130 performs:

Phase 310 comprises processing an inter-network message received in the apparatus to generate a protocol message based on the received inter-network message, the inter-network message comprising a first part and a second part, and phase 320 comprises transmit the protocol message toward a network function, for example in a core network of the rSEPP.

The first part is integrity protected but not encrypted and comprises first content elements of the protocol message, and the second part is integrity protected and encrypted and comprises second content elements of the protocol message as well as corresponding path elements indicating locations in the protocol message where the second content elements are located within the protocol message. (330 and 340).

An example embodiment is next described, in which:

The sSEPP 130 receives a protocol message (e.g. HTTP message) from the first network function 120 and does the following:

The sSEPP creates an inter-network message (e.g. a roaming message) which contains two parts: a first part for elements of the protocol message which, according to pre-defined policy, require integrity protection without encryption, and a second part for elements of the protocol message which, according to the pre-defined policy, require integrity protection with encryption. The first part is integrity protected but not encrypted, and the second part is integrity protected and encrypted, correspondingly. The first part, where the elements of the protocol message are legible to intermediate nodes such as nodes 140, may be modified by such nodes. These nodes may add patches to the inter-network message, which describe the change requested to the element(s) of the first part by the intermediate node(s). Elements in the first part may be referred to as first content elements and elements in the second part may be referred to as second content elements. Once the rSEPP receives the inter-network message with the patches, it may verify the changes are allowable, and then apply the changes when re-constituting a protocol message from the inter-network message.

In currently envisioned solutions, encrypted elements in the encrypted, second, part of the inter-network message (e.g. “dataToIntegrityProtectAndCipher”) are referenced from the clear text part, that is, the first part, of the inter-network message (e.g. “clearTextEncapsulatedMessage”) by inserting a reference of the form {“encBlockIdx”: <num>} in clear text in the un-encrypted first part. This reference is added by the sending SEPP, sSEPP, when it reformats the original protocol message.

A potential problem with the currently envisioned solutions is that the original sender of the protocol message can by mistake, or maliciously, cause misinterpretation of the received message at the receiving SEPP. For example, if an original HTTP message happens to contain attribute values of the form {“encBlockIdx”: <num>}, and in addition the sending SEPP inserts such references to the encrypted attribute values, this may lead to misinterpretation at the receiving SEPP side and consequently errors or possibly even enabled attacks. For example, if the original message already contains {“encBlockIdx”: 1} and the sending SEPP adds another element {“encBlockIdx”: 1}, the receiving SEPP may inadvertently replace both {“encBlockIdx”: 1}, with just the decrypted value.

It is also useful if intermediary nodes do not make modifications in the clear text part of the inter-network message (e.g. a “clearTextEncapsulatedMessage” block) through patch operations, based on entries in the encrypted part of the reformatted message (e.g. “dataToIntegrityProtectAndCipher”). The envisioned solutions allow this as the location of the encrypted value in the encrypted block is revealed by a reference that's inserted by the sending SEPP in the clear text section of the message. The location of the encrypted value may be presented as a clear-text index in the first part to an array of elements to be both integrity protected and encrypted (e.g. “dataToIntegrityProtectAndCipher”), that is, an index in the first part pointing to a location in the second part.

To address this, the sSEPP may omit from the first part indications of the location of specific second content elements in the encrypted second part. Thus the non-encrypted part of the inter-network message does not comprise locations, such as indexes, of the encrypted elements in the second, encrypted part. Rather, locations of specific second content elements in the original protocol message, for example paths, may be included exclusively in the second, encrypted, part of the inter-network message. The second part therefore encapsulates both the information (e.g. a path) that addresses the attribute whose value is to be encrypted, and the encrypted value itself. This enabled reconstruction of the protocol message in the rSEPP.

In one embodiment, the second part (e.g. “dataToIntegrityProtectAndCipher”) contains an array of patch operations conforming to the JSON Patch (RFC 6902) format. Each operation includes a JSON pointer path (RFC 6901) that identifies a specific value in the HTTP message. In another embodiment, the JSON Merge Patch format (RFC 7386) is used to represent the encrypted values in their structure. The operations enable reconstructing the original protocol message on the rSEPP. In a yet further embodiment, multiple JSON Merge Patch fragments are employed. In a further embodiment, in case of XML formatted messages, the format defined in RFC 5621, which uses XPath to encode location information, can be used can be used instead.

For a message that contains two attributes that need encryption in the HTTP message: a) Hdr2 in HTTP Headers and b) IE3 in HTTP Payload, the following JSON patch document captures: a) the location of the attribute in the reformatted HTTP message, represented as a JSON pointer, b) value of attribute that needs end to end encryption between two SEPPs and c) a “replace” operation that replaces the existing value of the attribute in the clearTextEncapsulatedMessage part of the reformatted message with the value of the attribute encapsulated in the dataToIntegrityProtectAndCipher block

```
    [
  {″op″: ″replace″, ″path″: ″/clearTextEncapsulatedMsg/HTTP_Headers/Hdr2″, ″value″:
″Hdr_value″},
  {″op″: ″replace″, ″path″: ″/clearTextEncapsulatedMsg/Payload/IE3″, ″value″: ″IE3_
Value″}
    ]
```

The first entry in the array is a replace operation to replace the existing attribute value in “Hdr2” with “Hdr_value”. The second entry performs a similar operation on information element IE3 in the HTTP Payload. The sending SEPP may first create the dataToIntegrityProtectAndCipher block in the inter-network message with the above two operations and then ciphers it, for example with JSON Web Encryption (JWE). Therefore, both critical pieces of the information—the location and the attribute value, are encrypted end-to-end between the sending SEPP and the receiving SEPP.

Once the original attribute value is encapsulated in the second part, the next step, in some embodiments, is to remove the attribute value in the first part. The attribute value may be replaced with a suitable replacement value, such as an empty string, empty structure or the number zero. In some embodiments, the replacement attribute value may be replaced with a suitable (e.g. random or dummy) value that serves the purpose of concealing the fact that the attribute is ciphered. Alternatively, an empty string (“ ”) may be used as a replacement.

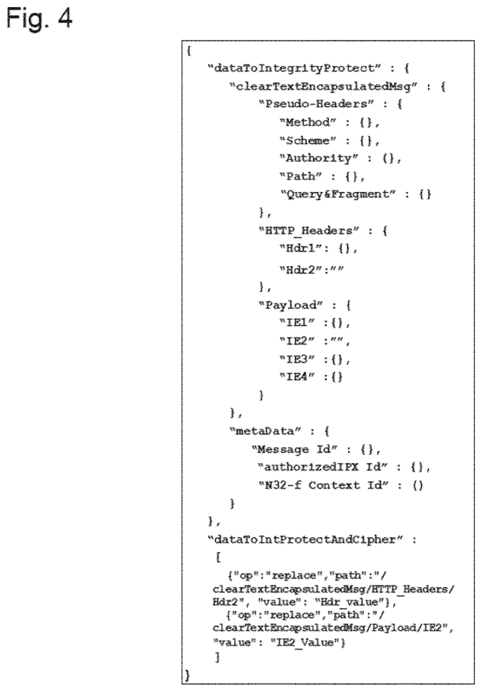

FIG. 4 shows an example of a message. FIG. 4 illustrates how an original HTTP message (i.e. first message) is transformed (to a second message) as it is processed by the sSEPP 130 at the edge and over a roaming interface. This is an example of encapsulating ciphered set of information based on JSON Patch and JSON Pointer. The rSEPP 130 verifies the received inter-network message, and reassembles the HTTP message therefrom.

FIG. 4 depicts two JSON Patch based “replace” operations encapsulated in a dataTolntegrityProtectAndCipher block. The first operation replaces the value of one of the HTTP headers, Hdr2, with the value “Hdr_value”. The second operation replaces one of the attributes in the payload, IE2, with the value, “IE2_Value”. The two operations are inserted by the sending SEPP in the dataTolntegrityProtectAndCipher block. As described in S3-182700, this data block is input to JSON Web Encryption (JWE) as plain text value. What comes out of JWE is the cipher text which is also integrity protected. Only the receiving SEPP has the necessary keys to decrypt the dataTolntegrityProtectAndCipher block. The values in the block is thus concealed from all the intermediaries including authorized IPX nodes. Depending on the deployment scenario, one of the SEPPs interacting over the 3^{rd} generation partnership project, 3GPP, N32 interface may be in Release 15 and using an older version of the protocol that was based on references. The SEPP, with the Release 16 version of the application layer security protocol, must be backward compatible and support Release 15 version of the protocol.

In an example embodiment, the rSEPP further determines which of the modifications comprised by the modification structure are acceptable; modifies the first elements only with the modifications that are acceptable; and performs the constructing of the reconstituted protocol message using the modification structure to the extent the modifications are acceptable.

FIG. 5 shows a block diagram of an apparatus 500 according to an embodiment. The apparatus may be used as a first network function 120, a SEPP 130, an intermediate node 140, or a second network function 150.

The apparatus 500 comprises a memory 530 including a persistent memory 532 that comprises computer program code 5322 and data 5324, and work memory 534. The apparatus 500 further comprises a processor 520 for controlling the operation of the apparatus 500 using the computer program code 5322, a communication circuitry 510 for communicating with other entities. The communication circuitry 510 comprises, for example, a local area network (LAN) port; a wireless local area network (WLAN) circuitry; Bluetooth circuitry; cellular data communication circuitry; or satellite data communication circuitry. The processor 520 comprises, for example, any one or more of: a master control unit (MCU); a microprocessor; a digital signal processor (DSP); an application specific integrated circuit (ASIC); a field programmable gate array; and a microcontroller. The processor 520 comprises in an example embodiment a processing circuitry comprising any one or more of: a master control unit (MCU); a microprocessor; a digital signal processor (DSP); an application specific integrated circuit (ASIC); a field programmable gate array; and a microcontroller. The processor may be formed of one or more processing elements. The processing elements are in an example embodiment distributed. In another example embodiment, the processing elements are comprised by one joint element.

As used in this application, the term “circuitry” may refer to one or more or all of the following:

(a) hardware-only circuit implementations (such as implementations in only analogue and/or digital circuitry) and;

(b) combinations of hardware circuits and software, such as (as applicable):
(i) a combination of analogue and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Without in any way limiting the scope, interpretation, or application of the claims appearing below, a technical effect of one or more of the example embodiments disclosed herein is that inter-network network function messaging can be flexibly protected. Another technical effect of one or more of the example embodiments disclosed herein is that an attack vector is closed, as described above, and the inter-network interface is rendered more resilient to accidental mis-interpretation of the inter-network messages. Further, intermediary IPX nodes are prevented from making patch modifications to the clear-text (first) part of the inter-network message which are based on the second, encrypted, part. This is so, since the location of elements in the second part is concealed by indicating a location of each second element in the protocol message only in the second part.

Embodiments may be implemented in software, hardware, application logic or a combination of software, hardware and application logic. In an example embodiment, the application logic, software or an instruction set is maintained on any one of various conventional computer-readable media. In the context of this document, a “computer-readable medium” may be any non-transitory media or means that can contain, store, communicate, propagate or transport the instructions for use by or in connection with an instruction execution system, apparatus, or device, such as a computer, with one example of a computer described and depicted in FIG. 5. A computer-readable medium may comprise a computer-readable storage medium that may be any media or means that can contain or store the instructions for use by or in connection with an instruction execution system, apparatus, or device, such as a computer.

If desired, the different functions discussed herein may be performed in a different order and/or concurrently with each other. Furthermore, if desired, one or more of the before-described functions may be optional or may be combined. Moreover, where reference is made to one component or entity, its functions may be distributed to or more sub-units, e.g. instead of one processor, a plurality of processors may perform some, though not necessarily all, operations of one entity.

Although various aspects are set out in the independent claims, other aspects comprise other combinations of features from the described embodiments and/or the dependent claims with the features of the independent claims, and not solely the combinations explicitly set out in the claims.

It is also noted herein that while the foregoing describes example embodiments, these descriptions should not be viewed in a limiting sense. Rather, there are several variations and modifications which may be made without departing from the scope as defined in the appended claims.

1-18. (canceled)

19. An apparatus,
the apparatus being a security edge proxy configured to implement application layer security for data exchanged between two core networks, the apparatus comprising at least one processing core, at least one memory including computer program code, the at least one memory and the computer program code being configured to, with the at least one processing core, cause the apparatus at least to:
process a protocol message received in the apparatus to generate an inter-network message based on the received protocol message, the inter-network message comprising a first part and a second part; and
transmit the inter-network message toward a second security edge proxy;
wherein the first part is integrity protected but not encrypted and comprises first content elements of the received protocol message;
wherein the second part is integrity protected and encrypted and comprises second content elements of the received protocol message as well as corresponding path elements indicating locations in the protocol message where the second content elements are located within the protocol message.

20. The apparatus according to claim 19, wherein the protocol is hypertext transfer protocol.

21. The apparatus according to claim 19, wherein the two core networks are cellular communication network core networks.

22. The apparatus according to claim 19, wherein the first part does not comprise indications of locations of the second content elements in the second part.

23. The apparatus according to claim 19, wherein the first part comprises indications of the second content elements wherein values of the second content elements are represented by replacement values or empty strings.

24. The apparatus according to claim 23, wherein the apparatus is configured to randomly generate the replacement values.

25. An apparatus,
the apparatus being a security edge proxy configured to implement application layer security for data exchanged between two core networks, the apparatus comprising at least one processing core, at least one memory including computer program code, the at least one memory and the computer program code being configured to, with the at least one processing core, cause the apparatus at least to:
process an inter-network message received in the apparatus to generate a protocol message based on the received inter-network message, the inter-network message comprising a first part and a second part; and
transmit the protocol message toward a network function;
wherein the first part is integrity protected but not encrypted and comprises first content elements of the protocol message; and
wherein the second part is integrity protected and encrypted and comprises second content elements of the protocol message as well as corresponding path elements indicating locations in the protocol message where the second content elements are located within the protocol message.

26. A method, comprising:
processing a protocol message received in the apparatus to generate an inter-network message based on the received protocol message, the inter-network message comprising a first part and a second part; and
transmitting the inter-network message toward a second security edge proxy;
wherein the first part is integrity protected but not encrypted and comprises first content elements of the received protocol message; and
wherein the second part is integrity protected and encrypted and comprises second content elements of the received protocol message as well as corresponding path elements indicating locations in the protocol message where the second content elements are located within the protocol message.

27. The method according to claim 26, wherein the protocol is hypertext transfer protocol.

28. The method according to claim 26, wherein the method is performed in a first security edge proxy configured to implement application layer security for data exchanged between two core networks, and the two core networks are cellular communication network core networks.

29. The method according to claim 26, wherein the first part does not comprise indications of locations of the second content elements in the second part.

30. The method according to claim 26, wherein the first part comprises indications of the second content elements wherein values of the second content elements are represented by replacement values or empty strings.

31. The method according to claim 30, further comprising randomly generating the replacement values.

32. A method, comprising:
processing an inter-network message received in the apparatus to generate a protocol message based on the received inter-network message, the inter-network message comprising a first part and a second part; and
transmitting the protocol message toward a network function;
wherein the first part is integrity protected but not encrypted and comprises first content elements of the protocol message; and
wherein the second part is integrity protected and encrypted and comprises second content elements of the protocol message as well as corresponding path elements indicating locations in the protocol message where the second content elements are located within the protocol message.
